(19) United States
(12) Patent Application Publication
(10) Pub. No.: US 2010/0302308 A1
(43) Pub. Date: Dec. 2, 2010

(54) INKJET RECORDING APPARATUS

(75) Inventor: Kazunari MATSUURA, Komaki-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/721,017

(22) Filed: Mar. 10, 2010

(30) Foreign Application Priority Data
May 26, 2009 (JP) 2009-125939

(51) Int. Cl. B41J 2/165

(52) U.S. Cl. 347/30

(57) ABSTRACT

An inkjet recording apparatus includes an inkjet head having an ejection surface on which a plurality of nozzles are formed, a cap including (1) a bottom surface portion, (2) an annular elastic member, (3) a plate member, and (4) at least one discharge outlet, and a discharge mechanism. The elastic member includes a contact portion which is provided on an inner circumferential surface thereof and which is configured to be distant from the plate member when the end portion of the elastic member is not in contact with the ejection surface, and to be in contact with the plate member along an outer circumference of the plate member by elastic deformation of the elastic member when the end portion of the elastic member is in contact with the ejection surface.

### CROSS REFERENCE TO RELATED APPLICATION

The present application claims priority from Japanese Patent Application No. 2009-125939, which was filed on May 26, 2009, the disclosure of which is herein incorporated by reference in its entirety.

### BACKGROUND OF THE INVENTION

1. Field of the Invention

The present invention relates to an inkjet recording apparatus which ejects ink to a recording medium.

2. Discussion of Related Art

There is known an inkjet recording apparatus which purges ink into a cap in order to recover ink ejection performance of a recording head. In the cap of the inkjet recording apparatus, there is provided a flow-regulating member that has a rectangular planar shape. The flow-regulating member has a plurality of holes that are dispersedly formed throughout a whole area of the flow-regulating member. The plurality of holes that are formed on a middle portion of the flow-regulating member are made smaller in diameter than the plurality of holes that are formed on opposite end portions of the flow-regulating member. Therefore, when ink in the cap is sucked through an ink discharge outlet, channel (passage) resistance from the middle portion to the ink discharge outlet is larger than that from the opposite end portions to the ink discharge outlet, so that the flow of ink in the cap can be equalized. As a result, the ejection performance of the recording head can be adequately recovered over an entire area thereof in a direction of nozzle rows.

### SUMMARY OF THE INVENTION

In the above-mentioned inkjet recording apparatus, the flow of ink is equalized when the ink in the cap is sucked. However, it is very difficult to suck all the ink in the cap. Especially, ink remains between a bottom surface of the cap and the flow-regulating member, and the residual ink becomes dry after a certain period of time has passed. When the cap in which the dry ink remains is left with covering an ejection surface of the recording head, the dry ink absorbs fluid from ink in the vicinity of nozzles of the recording head, so that viscosity of the ink in the vicinity of the nozzles is increased.

It is therefore an object of the present invention to provide an inkjet recording apparatus to, even in a case where the dry ink remains in the cap, restrain the dry ink in the cap from absorbing fluid from the ink in the vicinity of the nozzles.

According to the present invention, there is provided an inkjet recording apparatus comprising: at least one inkjet head having an ejection surface on which a plurality of nozzles for ejecting ink are formed; a cap including: a bottom surface portion which is allowed to be opposed to the ejection surface; an annular elastic member which stands upright from the bottom surface portion toward the ejection surface and which is allowed to contact the ejection surface in such a position thereof that an end portion of the elastic member encloses the plurality of nozzles of the ejection surface; a plate member which is supported by at least one of the bottom surface portion and the elastic member and is located in a recessed portion that is defined by the bottom surface portion and the elastic member; and at least one discharge outlet which is formed through at least one of the bottom surface portion and the elastic member and is located at a position nearer to the bottom surface portion than the plate member; and a discharge mechanism which is configured to discharge ink in the cap from the discharge outlet. The elastic member includes a contact portion which is provided on an inner circumferential surface thereof and which is configured to be distant from the plate member when the end portion of the elastic member is not in contact with the ejection surface, and to be in contact with the plate member along an outer circumference of the plate member by elastic deformation of the elastic member when the end portion of the elastic member is in contact with the ejection surface.

### BRIEF DESCRIPTION OF THE DRAWINGS

The above and optional objects, features, and advantages of the present invention will be better understood by reading the following detailed description of the preferred embodiments of the invention when considered in conjunction with the accompanying drawings, in which:

FIG. 1 is a perspective view showing an appearance of an inkjet printer as first embodiment to which the present invention is applied;

FIG. 2 is a side view schematically showing an internal structure of the inkjet printer;

FIG. 3A is a plan view of a cap, and FIG. 3B is a cross-sectional view taken along a line 3-3 in FIG. 3A;

FIGS. 4A and 4B are perspective views of a maintenance unit;

FIG. 5A is a side view of a part of the inkjet printer in one state of a capping operation, FIG. 5B is a side view of the part of the inkjet printer in another state of the capping operation, and FIG. 5C is a side view of the part of the inkjet printer in another state of the capping operation;

FIG. 6 is a view showing a control system of the inkjet printer;

FIG. 7A is a cross-sectional view showing a state in which ink is purged from an inkjet head of the inkjet printer into the cap, and FIG. 7B is a cross-sectional view showing a state in which an ejection surface of the inkjet head is covered by the cap;

FIG. 8A is a plan view showing a cap of an inkjet printer as second embodiment to which the present invention is applied, and FIG. 8B is a cross-sectional view taken along a line 8-8 in FIG. 8A; and

FIG. 9A is a cross-sectional view showing a state in which ink is purged from an inkjet head of the inkjet printer into the cap, and FIG. 9B is a cross-sectional view showing a state in which an ejection surface of the inkjet head is covered by the cap.

### DETAILED DESCRIPTION OF THE PREFERRED EMBODIMENTS

Hereinafter, there will be described preferred embodiments of the present invention with reference to the drawings.

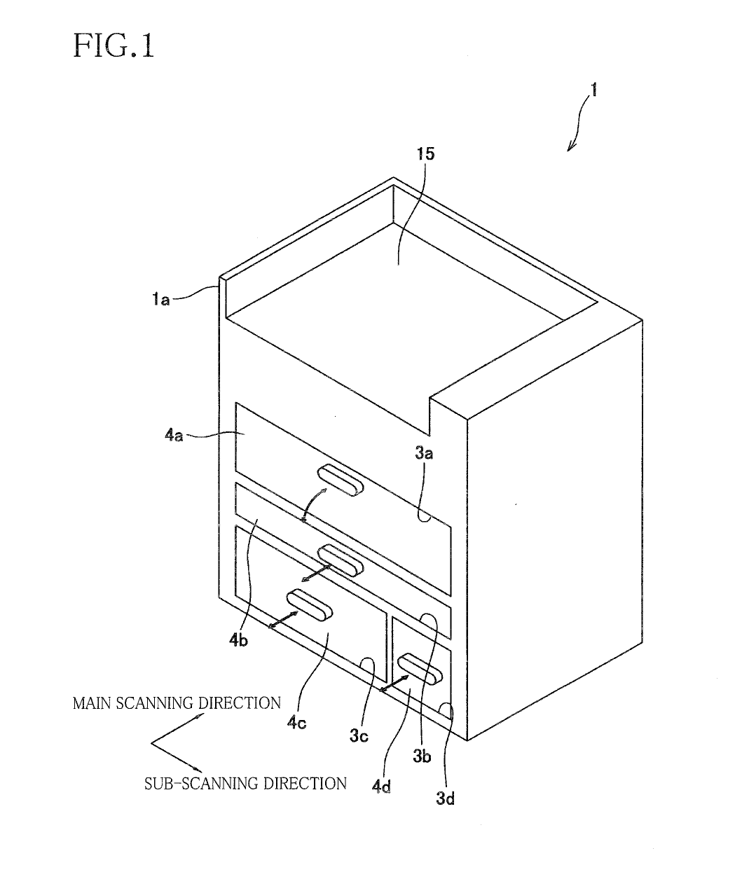

As shown in FIG. 1, an inkjet printer 1 as a first embodiment to which the present invention is applied includes a casing 1a having a rectangular parallelepiped shape, and our openings 3a through 3d are formed on a front surface of the casing 1a (a surface of a near side of a sheet plane of FIG. 1). In the opening 3a, there is disposed a door 3a that is pivotable to be opened and closed about a horizontal axis on a bottom end of the door 3a as a fulcrum. A sheet-supply unit 4b, an ink unit 4c, and a waste-ink unit 4d are inserted into the openings 3b, 3c and 3d, respectively. In an upper portion of the casing 1a, there is disposed a sheet-discharge portion 15. The door 4a is arranged to be opposed to a feed unit 50 in a main scanning direction (in a depth direction of FIG. 1).

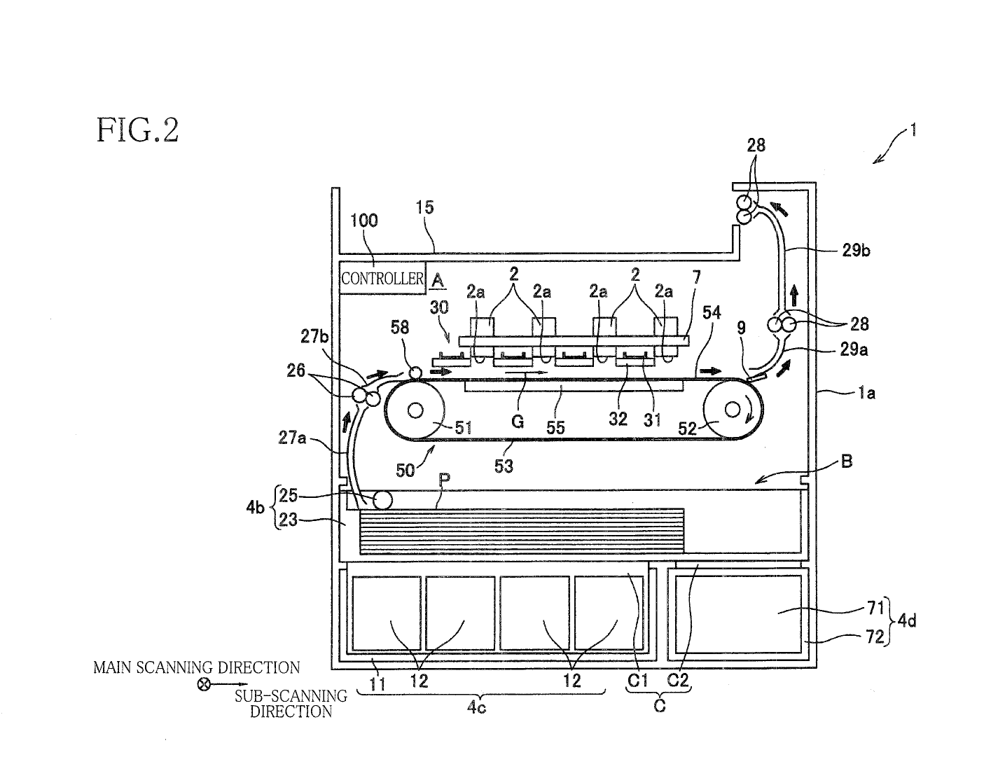

As shown in FIG. 2, a space inside the casing 1a of the inkjet printer 1 is divided into three spaces A, B, and C in the order from the top. In the space A, there are disposed four inkjet heads 2 to eject respective colors of inks including C (cyan), M (magenta), Y (yellow) and K (black) inks, a maintenance unit 30, and the feed unit 50.

The space B is a space in which the sheet-supply unit 4b is disposed. The space C is divided into two spaces C1, C2 that are arranged side by side in a sub-scanning direction. The space C1 is a space in which the ink unit 4c is disposed, and the space C2 is a space in which the waste-ink unit 4d is disposed. These units 4b through 4d are respectively attached to and detached from the casing 1a in the main scanning direction or a direction perpendicular to a sheet plane of FIG. 2. In the present embodiment, the sub-scanning direction is a direction parallel to a feeding direction G in which a recording sheet P as a recording medium is fed by the feed unit 50, and the main scanning direction is a direction perpendicular to the sub-scanning direction and extending along a horizontal surface. The inkjet printer 1 also includes a controller 100 that controls the sheet-supply unit 4b, the feed unit 50, the maintenance unit 30, the inkjet heads 2, and so forth.

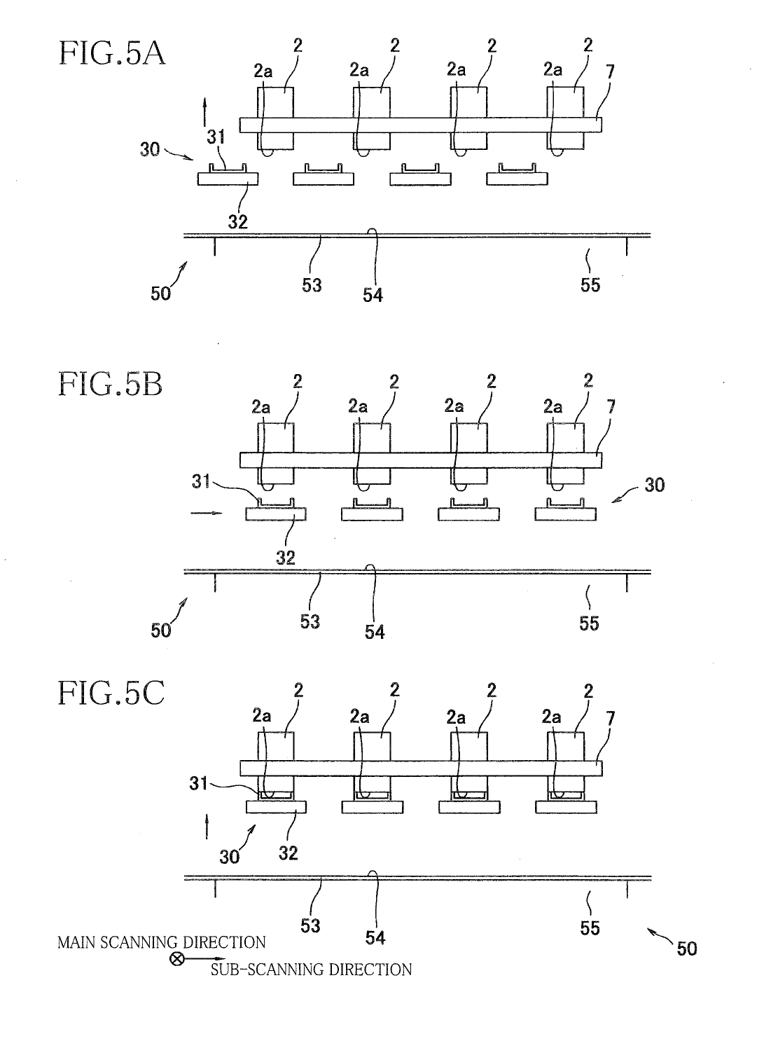

Each of the four inkjet heads 2 has generally rectangular parallelepiped shape extending in the main scanning direction and is fixed to a frame 7 in a state in which the respective four inkjet heads 2 are arranged to be adjacent to each other in the sub-scanning direction. In other words, the inkjet printer 1 is a line-type printer. Further, the frame 7 is arranged in the casing 1a to be movable up and down or in a vertical direction by a moving mechanism (not shown). The controller 100 controls the moving mechanism to move the inkjet heads 2 between a print position (a position shown in FIG. 2) and a retracted position (shown in FIG. 5A) that is upper than the print position.

Each of the inkjet heads 2 has a laminar structure in which a passage unit (not shown) that has an ink passage including a pressure chamber and an actuator (not shown) that applies a pressure on ink in the pressure chamber are stacked on, and adhered to, each other. A bottom surface of each of the inkjet heads 2 is an ejection surface 2a in which a plurality of nozzles or ejection openings (not shown) for ejecting ink are formed.

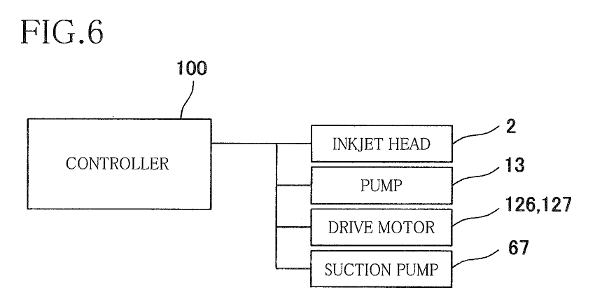

The ink unit 4c includes a cartridge tray 11 and four ink cartridges 12. The four ink cartridges 12 accommodate C, M, Y and K inks, respectively, in this order in the sub-scanning direction. When the ink unit 4c is attached to the casing 1a, the four ink cartridges 12 are respectively connected to respective ink supply passages (e.g., ink tubes, not shown) that are connected to the corresponding inkjet heads 2. On a middle portion of each ink supply passage, there is disposed a pump 13 (shown in FIG. 6) which, by control of controller 100, forcibly (forcedly) send ink in the ink cartridges 12 to the corresponding inkjet heads 2.

The waste-ink unit 4d includes an ink absorbing member 71 which consists of a porous component such as sponge and a vessel 72 that stores (accommodates) the ink absorbing member 71. The vessel 72 is communicated with a cap 31 that will be described later and accommodates ink that is discharged from the cap 31. The waste-ink unit 4d is attachable and detachable relative to the casing 1a, so that the waste-ink unit 4d can be easily replaced with a new one.

In the inkjet printer 1, there is formed a sheet feed path through which the recording sheet P is fed from the sheet-supply unit 4b to the sheet-discharge portion 15 along a thick arrow shown in FIG. 2. The sheet-supply unit 4b includes a sheet-supply tray 23 which can accommodate a plurality of recording sheets P and a sheet-supply roller 25 that is attached to the sheet-supply tray 23. The sheet-supply roller 25 feeds or supplies an uppermost one of the plurality of recording sheets P that are stored in the sheet-supply tray 23. The recording sheet P that is supplied by the sheet-supply roller 25 is fed to the feed unit 50, guided by guides 27a, 27b and nipped by a pair of feed rollers 26.

The feed unit 50 includes a pair of belt rollers 51, 52 and an endless feed belt 53 that is wound on the pair of belt rollers 51, 52 and is a feed device that feeds the recording sheet P in the feed direction G (indicated by an arrow G in FIG. 2). The belt roller 52 is a drive roller that is driven by a feed motor (not shown) and rotated in the clockwise direction in FIG. 2. The belt roller 51 is a driven roller that is rotated in the clockwise direction in FIG. 2 with circulation of the feed belt 53 by rotation of the belt roller 52.

An outer circumferential surface 54 of the feed belt 53 is adherent (viscous) due to silicon treatment. At a position in an opposed relationship with the belt roller 51 relative to the feed belt 53 on the sheet feed path, there is disposed a nip roller 58. The nip roller 58 presses the recording sheet P that is supplied from the sheet-supply unit 4b against the outer circumferential surface 54 of the feed belt 53. The recording sheet P that is pressed by the nip roller 58 against the outer circumferential surface 54 is kept on or supported by the outer circumferential surface 54 because of its adhesion and fed rightward in FIG. 2.

Inside an area that is surrounded by the feed belt 53, there is disposed a platen 55 which has a flat upper surface. As shown in FIG. 2, the upper surface of the platen 55 is in contact with an inner circumferential surface of an upper loop-shaped portion of the feed belt 53 so as to support the feed belt 53 from inside. Therefore, the outer circumferential surface 54 of the upper loop-shaped portion of the feed belt 53 and the ejection surface 2a of each inkjet head 2 are opposed to each other and in parallel with each other, and a small clearance suitable for printing is made between the outer circumferential surface 54 and the ejection surface 2a. The clearance constitutes a part of the sheet feed path. When the recording sheet P that is kept on the outer circumferential surface 54 of the feed belt 53 passes right below the four inkjet heads 2, the four inkjet heads 2 eject respective colors of inks toward an upper surface of the recording sheet P in order, so that a desired color image is formed on the recording sheet P.

At a position opposite to the belt roller 52 relative to the feed belt 53 on the sheet feed path, there is disposed a separate plate 9. The separate plate 9 separates the recording sheet P from the outer circumferential surface 54. The separated recording sheet P is fed and discharged to the sheet-discharge portion 15, guided by guides 29a, 29b and nipped by two pairs of feed rollers 28, respectively.

The maintenance unit 30 includes four plate-like member 32 that are equally spaced from each other in the sub-scanning direction, and the four caps 31 that are respectively fixed to the corresponding plate-like member 32 and can cover the respective ejection surfaces 2a of the corresponding inkjet heads 2. As shown in FIG. 2, the maintenance unit 30 is located between the four inkjet heads 2 and the feed unit 50.

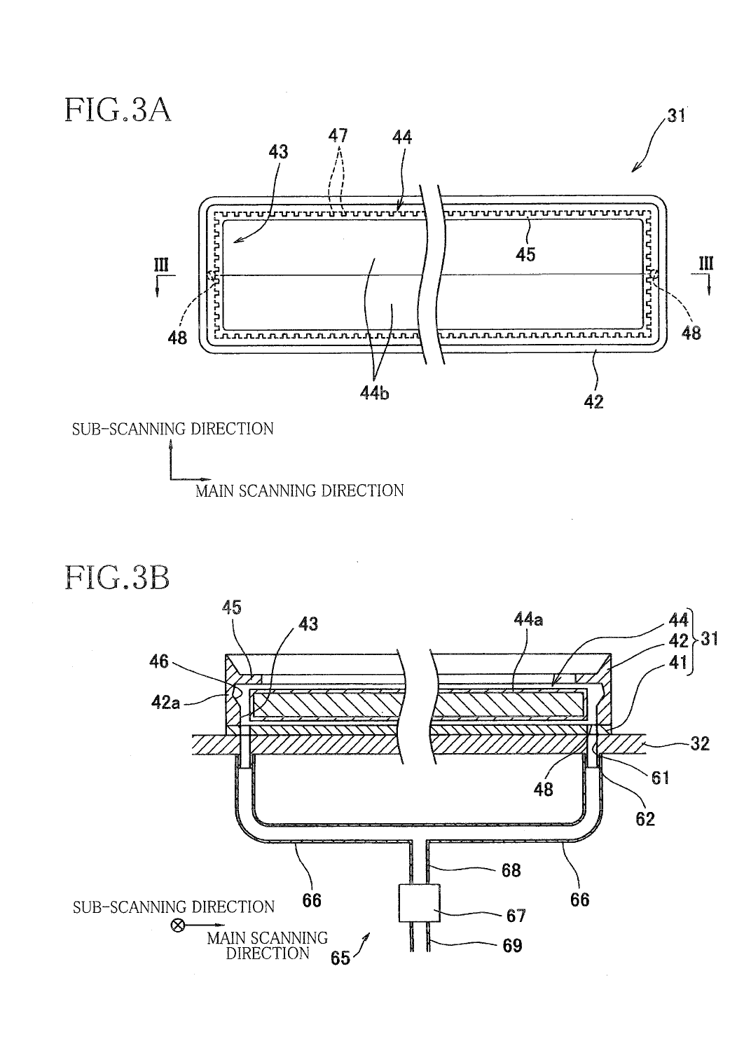

As shown in FIG. 3A, the cap 31 elongates along one direction, and a longitudinal direction of the cap 31 is in parallel with a longitudinal direction of the inkjet head 2 or the main scanning direction. The four caps 31 are respectively positioned at an upstream side in the feed direction G of the corresponding inkjet heads 2 in order not to disturb printing operation. More precisely, most upstream one of the four caps 31 is positioned at the upstream side in the feed direction G of most upstream one of the four inkjet heads 2, and the remaining three caps 31 are respectively positioned between the inkjet heads 2 adjacent to each other. With movement of the maintenance unit 30, the four caps 31 are movable up and down (in the vertical direction) and in a left-right direction in FIG. 2 relative to the corresponding inkjet heads 2.

As shown in FIG. 3B, the cap 31 includes: a plate-like support member 41 that forms a bottom surface portion of the cap 31; an annular elastic member 42 that defines a recessed portion 43 together with the support member 41; a cap chip 44 as a plate member that is supported by at least one of the support member 41 and the elastic member 42 and that is located in the recessed portion 43. The elastic member 42 stands upright from a periphery of an upper surface of the support member 41 and a top end thereof has a taper shape. The cap chip 44 is located in the recessed portion 43 in such a state that a periphery of the cap chip 44 is spaced from an inner circumferential surface of the elastic member 42. Further, the cap chip 44 functions in the recessed portion 43 as dividing an upper space of the recessed portion 43, which is located above the cap chip 44 and is closer to the ejection surface 2a, from a lower space thereof, which is below the cap chip 44 and is closer to a discharge hole 48 that will be described later. However, the cap chip 44 cannot thoroughly inhibit communication between the upper space of the recessed portion 43 that is closer to the ejection surface 2a and the lower space thereof that is closer to the discharge hole 48, and the upper space of the recessed portion 43 and the lower space thereof are in communication with each other through a through hole that is formed in the cap chip 44 in the vertical direction and a space between the periphery of the cap chip 44 and the inner circumferential surface of the elastic member 42. On the inner circumferential surface of the elastic member 42, there is formed an annular rib 45 which protrudes inwardly as a contact portion that is contactable with the cap chip 44. The rib 45 is located above an upper surface of the cap chip 44, and is distant from the cap chip 44 when an end portion of the rib 45 is not in contact with the ejection surface 2a.

In the present embodiment, the end portion of the rib 45 overlaps (is aligned with) the periphery of the cap chip 44 in the vertical direction. When the elastic member 42 contacts the ejection surface 2a, the end portion of the rib 45 is positioned outside an area of the ejection surface 2a in which the plurality of nozzles are formed. In other words, in a case where the ejection surface 2a is seen in a perpendicular direction or in the vertical direction, the rib 45 does not overlap any of the nozzles. In the inkjet printer 1, in order to maintain performance of ink ejection, a purge operation is performed, in which ink is forcibly discharged (exhausted). In the present embodiment, an upper surface of the rib 45 is prevented from being stained, caused by the purge operation.

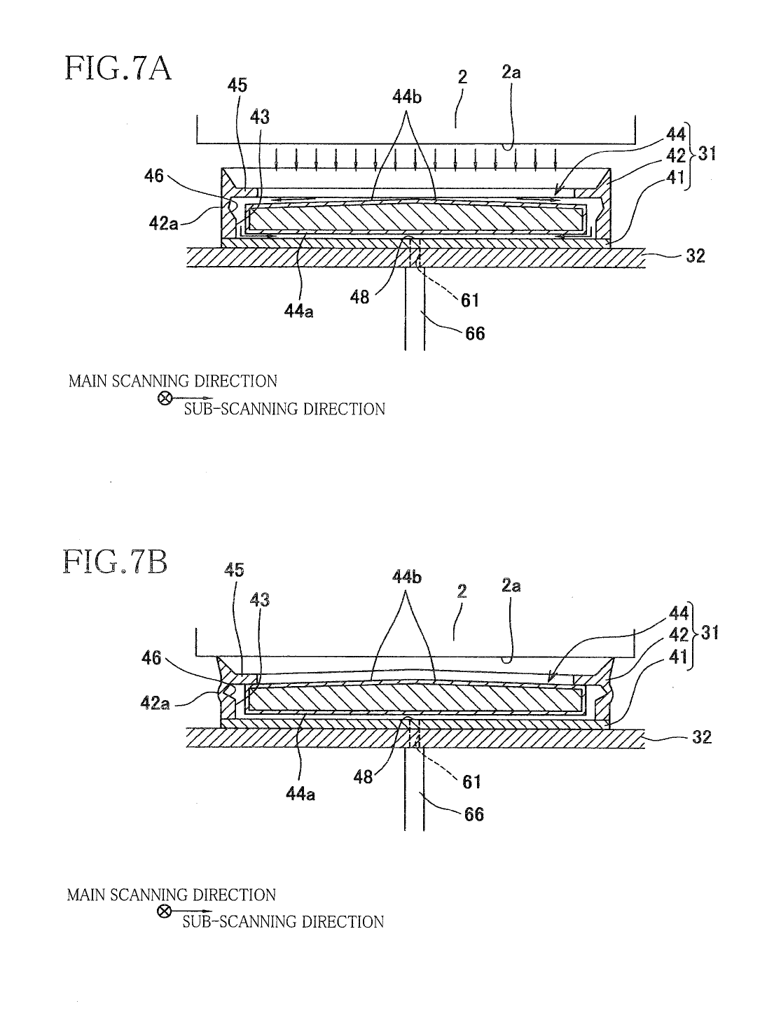

Further, in a lower portion of the elastic member 42 that is located under the rib 45, i.e., a portion thereof that is located from a bottom end portion to the rib 45, there is formed a thin portion 42a whose thickness is decreased. In the lower portion of the elastic member 42, the thin portion 42a has the least thickness. Therefore, when the elastic member 42 and the ejection surface 2a contact with each other, elastic deformation of the elastic member 42 easily occurs. Accordingly, when the elastic member 42 is elastically deformed, the rib 45 and the cap chip 44 surely contact with each other. The thin portion 42a is formed in such a way that a cutout 46 is formed in the inner circumferential surface of the elastic member 42 to extend over an entire circumference of the elastic member 42, that is, the thin portion 42a is formed to extend over the entire circumference of the elastic member 42. Thus, the elastic member 42 is elastically deformed at the thin portion 42a as a starting point more easily. Since the thin portion 42a is formed in the above-described way, when the top end of the elastic member 42 contacts the ejection surface 2a, by pressure force that occurs at the time, the thin portion 42a is elastically deformed so as to be curved outward (shown in FIG. 7B). Accordingly, the rib 45 is shifted downward and is fallen (inclined) inward easily, so that the rib 45 and a periphery of the upper surface of the cap chip 44 surely contact with each other over entire circumferences thereof.

In a capping operation of the ejection surface 2a as described above, while inner volume of the recessed portion 43 is reduced, inner pressure in the recessed portion 43 may be increased. Though it is likely to happen that meniscus formed in the nozzles of the inkjet head 2 is broken, caused by the increase of the inner pressure, the elastic deformation of the elastic member 42 at the thin portion 42a as the starting point eases the increase of the inner pressure, so that the meniscus is unlikely to be broken.

In order that the thin portion 42a is more certainly curved outward and the rib 45 contacts the cap chip 44 when the elastic member 42 contacts the ejection surface 2a, a point of application of force (a point of action of force) that is received from the ejection surface 2a may be located at a inner side of the recessed portion 43 from a midpoint of the thin portion 42a in a thickness direction thereof. Thus, when pressure force is applied to the cap 31, the thin portion 42a is easily buckled outward. Further, at least the end of the rib 45 may be inclined toward the cap chip 44, and it contributes to the contact of the rib 45 with the cap chip 44 with certainty. As mentioned above, when the rib 45 contacts the cap chip 44, in the recessed portion 43, an upper space and lower space are separated from each other, so that residual ink in the lower space has little effect on ink in the nozzles that are exposed on the upper space.

As shown in FIG. 3B, there are formed two discharge holes (discharge outlets) 48 in the support member 41 as the bottom surface portion of the recessed portion 43. The discharge holes 48 are located at opposite end portions of the support member 41 in the main scanning direction and at a middle portion thereof in the sub-scanning direction. The discharge holes 48 are also located at respective positions opposite to a clearance (a space) between the cap chip 44 and the inner circumferential surface of the elastic member 42.

As shown in FIG. 3B, at respective positions of the plate-like member 32 that are opposite to the respective discharge holes 48, there are formed holes 61 that respectively communicate with the discharge holes 48. Further, on a bottom surface of the plate-like member 32, there are formed tubular joint portions 62 that respectively extend downward from peripheries of the respective holes 61. A diverging pipe or branched pipe 66 or of an discharge mechanism 65 is connected to each joint portion 62, and the diverging pipe 66 and the hole 61 are communicated with each other.

The discharge mechanism 65 includes a suction pump 67, a pipe 68 that is connected to the suction pump 67, eight diverging pipes 66 that are diverged from the pipe 68, a pipe 69 through which the suction pump 67 and the vessel 72 communicate with each other. In FIG. 3B, a pipe arrangement (configuration) of one plate-like member 32 is shown as an example. Two diverging pipes 66 are connected to each plate-like member 32, and the pipe 68 is connected to eight diverging pipes 66 in total. The suction pump 67 operates by control of the controller 100 such that ink in the cap 31 is discharged to the waste-ink unit 4d through the discharge hole 48, the holes 61, the diverging pipes 66, and the pipes 68, 69.

The cap chip 44 has a rectangular planer shape, and a longitudinal direction of the cap chip 44 is in parallel with the longitudinal direction of the inkjet head 2. Further, the cap chip 44 is located on the support member 41 such that a clearance between an outer circumferential side surface of the cap chip 44 and the inner circumferential surface of the elastic member 42 is generally equalized over an entire circumferences of the cap chip 44 and the elastic member 42.

As shown in FIG. 3B, on a whole surface of the cap chip 44, there is formed a water repellent layer 44a by water repellent finishing. Therefore, ink that is purged from the inkjet head 2 to an inside of the cap 31 can easily flow and is hardly stayed on the cap chip 44. Further, on the upper surface of the cap chip 44, there are formed inclined surfaces 44b that are respectively inclined downward from a middle portion of the cap chip 44 to opposite end portions thereof in the sub-scanning direction. Accordingly, the purged ink can easily flow from the upper surface of the cap chip 44 to a side of a bottom surface of the recessed portion 43, so that the purged ink becomes harder to be stayed on the cap chip 44.

As shown in FIG. 3A, on the outer circumferential side surface of the cap chip 44, i.e., a side surface of the cap chip 44 that is opposed to the inner circumferential surface of the elastic member 42, there are formed a plurality of grooves 47 extending in the vertical direction. The groove 47 has a width enough to produce capillary action. Therefore, when ink and the groove 47 contact with each other in the vicinity of a periphery of the upper surface of the cap chip 44, the ink is drawn toward the groove 47 by capillary force produced in the groove 47. Accordingly, the ink can effectively flow toward the bottom surface of the recessed portion 43, with the result that the ink is hard to be stayed on the upper surface of the cap chip 44.

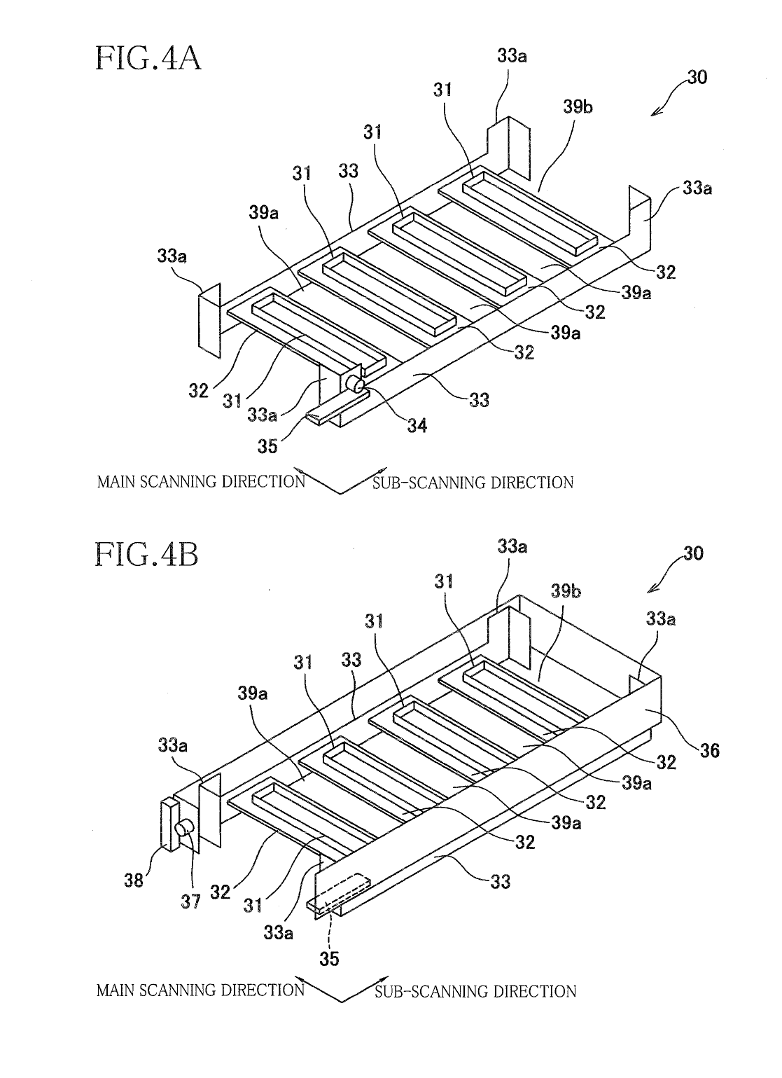

The maintenance unit 30 includes a pair of inner frames 33 that hold the respective plate-like members 32 therebetween, a pair of outer frames 36 that are arranged to be opposed to the respective inner frames 33 from outside, a horizontal movement mechanism (device) that moves the inner frames 33 in a horizontal direction (in the feed direction G), and a vertical movement mechanism (device) that moves the inner frames 33 in the vertical direction. As shown in FIG. 4A, each inner frame 33 has corners 33a that respectively extend upward on opposite end portions of the inner frame 33 in a direction of extension of the inner frame 33 or a lengthwise direction thereof.

The horizontal movement mechanism mainly consists of a drive motor 126 (shown in FIG. 6) and a rack and pinion. As shown in FIG. 4A, a rack gear 35 that has a flat plate structure is fixed to one of the corners 33a in such a way that a lengthwise direction of the rack gear 35 extends in the horizontal direction. A circular pinion gear 34 is fixed to an axis of the drive motor 126 and arranged to mesh with the rack gear 35. The above-mentioned horizontal movement mechanism is disposed at each of the pair of inner frames 33. In FIG. 4A, only the pinion gear 34 on the inner frame 33 on a near side of a sheet plane of FIG. 4A is shown.

The vertical movement mechanism mainly consists of a drive motor 127 (shown in FIG. 6) and a rack and pinion. As shown in FIG. 4B, a rack gear 38 that has a flat plate structure is fixed to one of opposite end portions of the outer frame 36 in such a way that a lengthwise direction of the rack gear 38 extends in the vertical direction. A circular pinion gear 37 is fixed to an axis of the drive motor 127 and arranged to mesh with the rack gear 38. The rack gear 38 may be fixed to either one of a side of the outer frame 36 and a side of a body frame of the casing 1a, and in the present embodiment, the rack gear 38 is fixed to the side of the body frame. The rack gear 35 may be fixed to either one of a side of the inner frame 33 (the corner 33a) and a side of the outer frame 36, and in the present embodiment, the rack gear 35 is fixed to an inside of the outer frame 36.

In the above-described construction, by control of controller 100, two pinion gears 34 are synchronously rotated, so that the pair of inner frames 33 moves relative to the outer frames 36 in the sub-scanning direction. Further, by control of controller 100, the pinion gear 37 is rotated, so that the inner and the outer frames 33, 36 move in a direction perpendicular to the sub-scanning direction or in the vertical direction.

More precisely, in order not to disturb the printing operation, three openings 39a that are formed between the respective four plate-like members 32 and an opening 39b that is formed between the plate-like member 32 that are located on the most downstream side in the feed direction G (in the sub-scanning direction) and the corners 33a are respectively opposed to the four ejection surfaces 2a. Hereinafter, the above-mentioned state is referred to as an initial state. In the initial state, when the capping operation for covering ejection surfaces 2a by the caps 31 is started, as shown in FIG. 5A, the four inkjet heads 2 are moved from the print position to the retracted position by the moving mechanism.

Next, as shown in FIG. 5B, the pair of inner frames 33 are moved to the downstream side in the feed direction G by the horizontal movement mechanism and positioned at a position where the caps 31 are respectively opposite to the corresponding ejection surfaces 2a. Then, as shown in FIG. 5C, the outer frames 36 are moved up in the perpendicular (vertical) direction by the vertical movement mechanism and positioned at a capping position where the caps 31 (the elastic members 42) are respectively pressed on the corresponding ejection surfaces 2a so as to cover the ejection surfaces 2a. Through the above steps, the plurality of nozzles of the corresponding ejection surfaces 2a are covered by the recessed portions 43 of the respective caps 31. In a case where the printing operation is restarted, through steps that are reverse to the above steps, the caps 31 are returned to an initial position or the initial state and the inkjet heads 2 are positioned at the print position. On the other hand, in cases where the printing operation is not required after the capping operation or where the inkjet printer 1 is stopped, the caps 31 are retained at the capping position.

Hereinafter, the controller 100 will be described based on FIG. 6. The controller 100 mainly consists of, e.g., a general-purpose personal computer (PC). The PC includes a CPU (Central Processing Unit), a ROM (Read Only Memory), a RAM (Random Access Memory), hardware including a hard disk. In the hard disk, various sorts of software are stored, including programs for controlling operations of the inkjet printer 1. The controller 100 controls the inkjet heads 2, the moving mechanism, the drive motors 126, 127, the pump 13, the suction pump 67, and so forth.

Hereinafter, a maintenance operation will be described with reference to FIGS. 5 and 7. The maintenance operation includes the purge operation, a waste-ink treatment operation, the capping operation, and so on. In a case where ejection defect and so on occur in the inkjet heads 2, the purge operation is performed, purging (or forcibly discharging) ink from the nozzles of the inkjet head 2. In this case, the controller 100 controls the moving mechanism to move the inkjet heads 2 from the print position to the retracted position (shown in FIG. 5A). Then, the controller 100 controls the drive motor 126 to move the caps 31 to the position that is opposite to the ejection surfaces 2a (shown in FIG. 5B). The controller 100 then controls the drive motor 127 to move the caps 31 toward the ejection surfaces 2a, as shown in FIG. 7A. At this time, each cap 31 is positioned at a purge position in which the top end of the elastic member 42 and the ejection surface 2a are slightly distant from each other.

Next, the controller 100 drives the pump 13 for a predetermined time to forcibly send ink in the ink cartridge 12 to the inkjet head 2. As a result, ink in the inkjet head 2 is purged into the cap 31. At this time, the purged ink is, as shown in FIG. 7A, flown along the inclined surface 44b and into the space between the cap chip 44 and the inner circumferential surface of the elastic member 42. Further, in the vicinity of the periphery of the upper surface of the cap chip 44, ink cannot be remained and is drawn toward the bottom surface of the recessed portion 43 by the grooves 47 that are formed on the outer circumferential side surface of the cap chip 44. The ink thus flows toward the side of the bottom surface of the recessed portion 43.

After the purge operation is finished, the controller 100 drives the suction pump 67 to perform the waste-ink treatment operation. In other words, the controller 100 drives the suction pump 67 for a predetermined time (twenty to thirty seconds) to suck ink in each cap 31 through the discharge hole 48 and discharge it to the waste-ink unit 4d. At the time, the rib 45 is opposite to the upper surface of the cap chip 44 with a slight clearance formed, so that air current toward the periphery of the cap chip 44 is produced along the upper surface of the cap chip 44. Along with the air current, a part of the ink is moved on the cap chip 44 toward the periphery thereof. Most of the ink in the cap 31 is discharged to the waste-ink unit 4d.

In a case where the printing operation is performed to the recording sheet P after the waste-ink treatment operation, the controller 100 controls the drive motors 127, 126 to move the caps 31 from the purge position to the initial position. At this time, ink that is adhered to the ejection surface 2a by the purge operation may be wiped off by a wiping mechanism (device), not shown. Then, the controller 100 controls the moving mechanism to move the inkjet heads 2 from the retracted position to the print position to perform the printing operation to the recording sheet P.

In a case where the capping operation is performed after the printing operation, the controller 100 controls the moving mechanism to move the inkjet heads 2 to the retracted position. After that, the controller 100 controls the drive motors 126, 127 to position the respective caps 31 at the position opposite to the corresponding ejection surfaces 2a and then at the capping position, as shown in FIG. 7B. In a case where the printing operation is not performed after the waste-ink treatment operation and the capping operation is performed, the controller 100 controls the drive motor 127 to move the respective caps 31 from the purge position to the capping position.

In the capping operation, the elastic member 42 is pressed on the ejection surface 2a, and the thin portion 42a of the elastic member 42 is elastically deformed so as to be curved outward. By the elastic deformation of the elastic member 42, the rib 45 is displaced so as to be inclined toward the inside of the recessed portion 43. At this time, the rib 45 contacts the periphery of the upper surface of the cap chip 44 over the entire periphery thereof, and the upper space that is located upper than the rib 45 of the recessed portion 43 and the lower space that is located lower than the rib 45 is inhibited from communicating with each other. The capping operation is thus completed.

In the inkjet printer 1 in the present embodiment, when the ejection surface is covered by the cap 31 or in a capping state, the rib 45 contacts the periphery of the upper surface of the cap chip 44 over the entire periphery thereof, so that the lower space below the rib 45 and the upper space above the rib 45 hardly communicate with each other. Therefore, even in a case where dry ink is remained in the bottom surface of the recessed portion 43, it is restrained that the dry ink absorbs fluid of ink in the vicinity of the nozzles of the inkjet head 2. Accordingly, viscosity of ink in the vicinity of the nozzles in the capping state can be restrained.

Further, the rib 45 is located above the cap chip 44 so as to be contactable with the periphery of the upper surface of the cap chip 44 by the elastic deformation of the elastic member 42. The rib 45 can surely contact the cap chip 44 with such a simple structure.

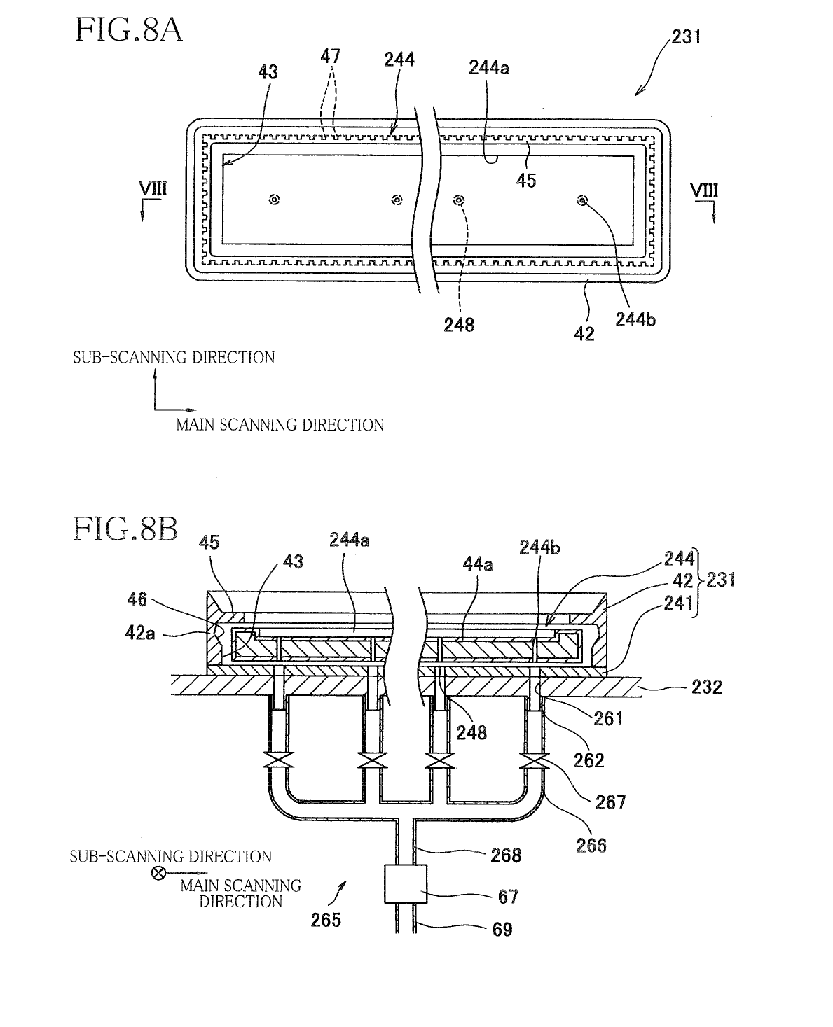

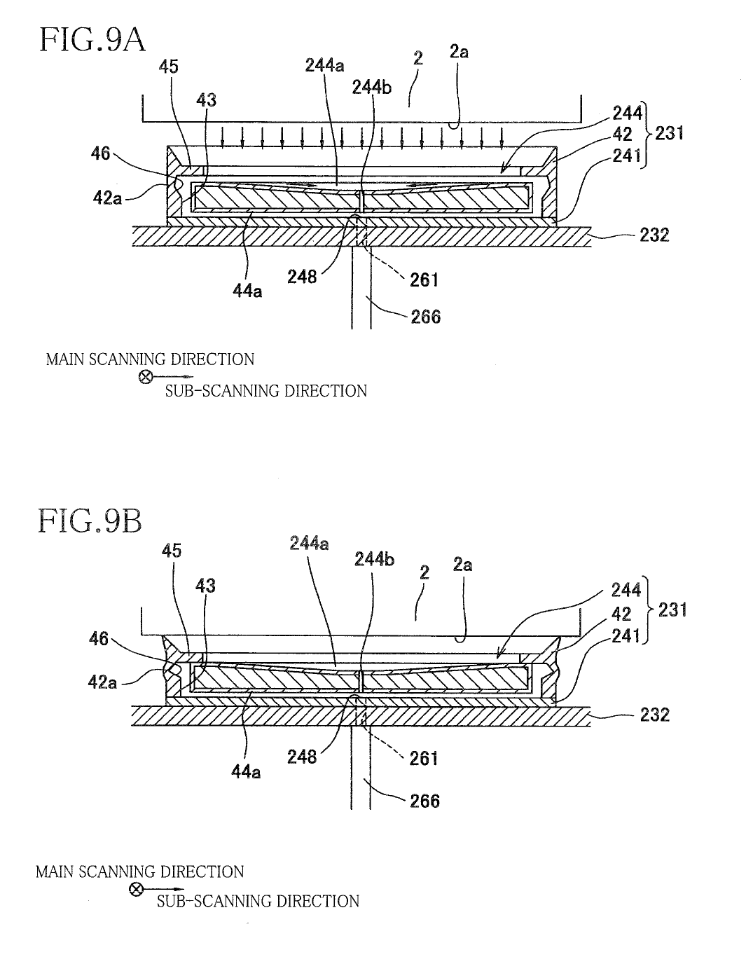

Hereinafter, there will be described an inkjet printer as a second embodiment of the present invention with reference to FIGS. 8, 9. In the present embodiment, mainly the cap 231 and the discharge mechanism 265 are different from the cap 31 and the discharge mechanism 65 in the first embodiment, and the other components are structured in the same way as the first embodiment. The components that are structured in the same way as the first embodiment are shown by the same reference numerals as the first embodiment and descriptions thereof are omitted.

The cap 231 in the present embodiment includes, as shown in FIG. 8B, a support member 241, the elastic member 42, and a cap chip 244 that is disposed in the recessed portion 43. The cap chip 244 has a planar shape and a planer size similar to the cap chip 44 in the first embodiment and is disposed on the support member 241 such that a slight clearance is fowled between the cap chip 244 and the inner circumferential surface of the elastic member 42.

In a middle of the cap chip 244, there is formed a recessed portion 244. The recessed portion 244a is structured such that a middle portion of an upper surface of the cap chip 244 is more curved downward than opposite end portions thereof in the sub-scanning direction (shown in FIGS. 9A, 9B). Further, on a bottom surface of the recessed portion 244a, there are formed four holes 244b that penetrate the cap chip 244 in a thickness direction thereof. The four holes 244b are arranged at equal intervals in the main scanning direction in the middle portion of the recessed portion 244a in the sub-scanning direction. Therefore, ink that is purged into the cap 231 is easily gathered in the middle portion of the upper surface of the cap chip 244, and the gathered ink easily flows from the recessed portion 244a toward the bottom surface of the recessed portion 43 through the holes 244b. Accordingly, the ink hardly remains on the upper surface of the cap chip 244. Further, a plurality of the holes 244b are formed in the cap chip 244, so that the purged ink flows more easily from the recessed portion 244a toward the bottom surface of the recessed portion 43.

In the support member 241, there are formed four discharge holes (discharge outlets) 248 at positions that are respectively opposite to the corresponding holes 244b. Further, as shown in FIG. 8B, in a plate-like member 232, there are formed holes 261 at positions that are respectively opposite to the corresponding discharge holes 248, communicating with the corresponding discharge holes 248. There are also disposed tubular joint portions 262 on a bottom surface of the plate-like member 232 that respectively extend downward from peripheries of the corresponding holes 261. The joint portions 262 are respectively connected to diverging pipes 266 of the discharge mechanism 265, and the respective diverging pipes 266 and the holes 261 communicate with each other.

The discharge mechanism 265 includes the suction pump 67, a pipe 268 that is connected to the suction pump 67, sixteen diverging pipes 266 that are diverged from the pipe 268, sixteen switching valves (transfer valves) 267 that are disposed in a middle of the respective diverging pipes 266, and the pipe 69. By control of the controller 100, the switching valves 67 are switched between a communication state and a cutoff state. Though, in FIG. 8B, four diverging pipes 266 that are respectively connected to the joint portions 262 of one plate-like member 232 are shown, four diverging pipes 266 are respectively connected to each plate-like member 232, i.e., the pipe 268 is connected to the sixteen diverging pipes 266 in total. The controller 100 controls the suction pump 67 to discharge ink in the cap 231 to the waste-ink unit 4d through the discharge holes 248, the holes 261, the diverging pipes 266, the pipes 268, 69.

Hereinafter, the maintenance operation will be described with reference to FIGS. 9A and 9B. In the present embodiment, in a case where the purge operation is performed, as in the first embodiment, the inkjet heads 2 are moved from the print position to the retracted position, and the respective caps 231 are positioned at the purge position from the initial position. Then, as shown in FIG. 9A, ink is purged from the inkjet head 2 into the cap 231. The purged ink is gathered in the middle portion of the upper surface of the cap chip 244 along a curved shape thereof, and then, the purged in flows into the bottom surface of the recessed portion 43 through the holes 244b.

After the purge operation is finished, the waste-ink treatment operation is performed. The controller 100 drives the suction pump 67 to suck ink in the respective caps 231 from the discharge holes 248 and discharge it to the waste-ink unit 4d. At the time, the controller 100 controls all the switching valves 267 in the communication state until a first predetermined time (e.g., fifteen seconds) has passed since the suction pump 67 starts to be driven. During the first predetermined time, most of the ink in the cap 231 is discharged to the waste-ink unit 4d. Then, after the first predetermined time passed, only one of the four switching valves 267 corresponding to the respective caps 231 is kept in the communication state for a second predetermined time (e.g., five seconds). The above-described control is executed with respect to the remaining three switching valves 267 in order after the second predetermined time passed. In the present embodiment, though the second predetermined time is shorter than the first predetermined time, the second predetermined time may be longer than the first predetermined time, or the second predetermined time may be identical with the first predetermined time.

As mentioned above, since the respective switching valve 267 are disposed in the corresponding diverging pipe 266, ink can be sucked with respect to each diverging pipe 266 in one cap 231. Therefore, ink may be sucked simultaneously from all the diverging pipes 266 or may be sucked from each diverging pipe 266 with a stronger suction force. Because the suction force in the diverging pipe 266 can be increased, the suction force that acts on the discharge hole 248 and the hole 244b opposite to the diverging pipe 266 with the increased suction force can be also increased, so that plugging of these discharge hole 248 and the hole 244b can be cleared. In addition, in order to increase the suction force in the diverging pipe 266, installation of a plurality of suction pumps and a large-sized suction pump are unnecessary.

Furthermore, in ink suction from all the diverging pipes 266, in a case where ink that should be sucked from a surrounding area of one diverging pipe 266 is drained, only this diverging pipe 266 communicates with an inner space of the recessed portion 43. At this time, the suction force is mainly used for air suction from the above-mentioned diverging pipe 266 and not used for ink suction from the other diverging pipes 266. However, followed by the ink suction from all the diverging pipes 266, the ink suction is performed from each diverging pipe 266 individually, so that ink on the cap chips 244 can be equally removed over generally entire surfaces thereof.

In a case where the printing operation is performed to the recording sheet P after the waste-ink treatment operation, as in the first embodiment, the respective caps 31 are moved back to the initial position from the purge position. At this time, ink that is adhered to the ejection surface 2a by the purge operation may be wiped off by a wiping mechanism, not shown. Then, the inkjet heads 2 moved back to the print position from the retracted position to perform the printing operation to the recording sheet P.

In a case where the capping operation is performed after the printing operation, and in a case where the capping operation is performed without the printing operation after the waste-ink treatment operation, the same control as the first embodiment is executed. Therefore, in the present embodiment, as shown in FIG. 9A, the thin portion 42a of the elastic member 42 is elastically deformed so as to be curved outward and the rib 45 is displaced so as to be inclined toward the inside of the recessed portion 43. At this time, the rib 45 contacts the periphery of the upper surface of the cap chip 244 over the entire periphery thereof, and the upper space that is upper than the rib 45 of the recessed portion 43 and the lower space that is lower than the rib 45 is inhibited from communicating with each other. The capping operation is thus completed.

In the inkjet printer in the present embodiment, as in the first embodiment, in the capping state, the lower space below the rib 45 and the upper space above the rib 45 hardly communicate with each other. Therefore, even in a case where dry ink is remained in the bottom surface of the recessed portion 43, it is restrained that the dry ink absorbs fluid of ink in the vicinity of the nozzles of the inkjet head 2. Accordingly, viscosity of ink in the vicinity of the nozzles in the capping state can be restrained. In the present embodiment, structures similar to the first embodiment can enjoy the same effects.

The present invention is not limited to the illustrated embodiments. It is to be understood that the present invention may be embodied with various changes and modifications that may occur to a person skilled in the art, without departing from the spirit and scope of the invention defined in the appended claims. For example, the rib, which is contactable with the cap chip when the ejection surface 2a is covered by the cap and the elastic member 42 is elastically deformed, may be located at a position that is opposite to the outer circumferential side surface of the cap chip. In this case, the rib is contactable with the outer circumferential side surface of the cap chip, so that the similar effect in the first and the second embodiments can be obtained. In a case where the outer circumferential side surface of the cap chip is a smooth flat surface, water-tightness seal between the cap chip and the rib can be improved.

In the illustrated embodiments, the rib that is contactable with the cap chip is formed so as to extend inward from the inner circumferential surface of the elastic member. Instead of the rib that is disposed in the elastic member, a portion of the elastic member that is located above the cap chip may be a contact portion, which is inclined inward when the elastic member is elastically deformed and the inner circumferential surface of the elastic member contacts the cap chip.

In the illustrated embodiments, though the cap is structured such that the support member and the elastic member are individual or independent members, the support member and the elastic member may be integrally formed of an elastic material.

In the second embodiment, as in the first embodiment, the cap chip 244 is arranged such that the periphery of the cap chip 244 is distant from the inner circumferential surface of the elastic member 42. In the second embodiment, however, the cap chip 244 may be arranged such that the periphery of the cap chip 244 is in contact with the inner circumferential surface of the elastic member 42. In the second embodiment, since the holes 244b are formed in the middle portion of the upper surface of the cap chip 244, ink can be discharged to the discharge mechanism 265 through the holes 244b. In a case that this structure is adopted, the cap chip 244 is certainly supported by the elastic member 42, so that the accuracy of assembly of the cap 231 can be improved.

Further, the thin portion 42a may not be formed over the entire circumference of the elastic member 42, and may not be formed in the elastic member 42. The thin portion 42a may also be elastically deformed toward the inside of the recessed portion 43 when the elastic member 42 and the ejection surface 2a contact with each other. In this case, increase of the inner pressure in the recessed portion 43 is promoted by contact of the elastic member 42 and the ejection surface 2a. Therefore, the inside of the recessed portion 43 may communicate with the atmosphere until the contact of the elastic member 42 and the ejection surface 2a is completed. In this case, the inside of the recessed portion 43 may communicate with the atmosphere through passage for discharging ink, or another passage that is communicable with the atmosphere may be further disposed. The above-mentioned atmosphere communication operation is also effective in such a structure that the recessed portion 43 is deformed outward.

Furthermore, the upper surfaces of the cap chips 44, 244 may be flat. The grooves 47 may not be formed on the outer circumferential side surfaces of the cap chips 44, 244. The water-repellent layer 44a may formed only on the upper surfaces of the cap chips 44, 244, and the cap chips 44, 244 may have no water-repellent layer.

The rib may not be formed over the entire inner circumferential surface of the elastic member 42. In a case where the lower space and the upper space that are defined by the rib and the upper surface of the cap chip communicate with each other with a high passage resistance, increased viscosity of ink can be prevented for a relatively long time period.

Furthermore, the maintenance unit 30 may not have the (vertical) movement mechanism. In this case, the moving mechanism for moving the inkjet heads 2 can function as the vertical movement mechanism.

What is claimed is:

1. An inkjet recording apparatus comprising:
at least one inkjet head having an ejection surface on which a plurality of nozzles for ejecting ink are formed;
a cap including:
a bottom surface portion which is allowed to be opposed to the ejection surface;
an annular elastic member which stands upright from the bottom surface portion toward the ejection surface and which is allowed to contact the ejection surface in such a position thereof that an end portion of the elastic member encloses the plurality of nozzles of the ejection surface;
a plate member which is supported by at least one of the bottom surface portion and the elastic member and is located in a recessed portion that is defined by the bottom surface portion and the elastic member; and
at least one discharge outlet which is formed through at least one of the bottom surface portion and the elastic member and is located at a position nearer to the bottom surface portion than the plate member; and
a discharge mechanism which is configured to discharge ink in the cap from the discharge outlet; and
wherein the elastic member includes a contact portion which is provided on an inner circumferential surface thereof and which is configured to be distant from the plate member when the end portion of the elastic member is not in contact with the ejection surface, and to be in contact with the plate member along an outer circumference of the plate member by elastic deformation of the elastic member when the end portion of the elastic member is in contact with the ejection surface.

2. The inkjet recording apparatus according to claim 1, wherein the contact portion is located at a position upper than the plate member and is configured to contact an upper surface of the plate member by elastic deformation of the elastic member when the end portion of the elastic member contacts the ejection surface.

3. The inkjet recording apparatus according to claim 1, wherein the contact portion consists of an annular rib that is formed on the inner circumferential surface of the elastic member.

4. The inkjet recording apparatus according to claim 1, wherein a thin portion is formed in a position of the elastic member between the contact portion and the bottom surface portion.

5. The inkjet recording apparatus according to claim 4, wherein the thin portion extends over an entire circumference of the elastic member.

6. The inkjet recording apparatus according to claim 4, wherein the thin portion is elastically deformed toward an outer circumference of the elastic member when the end portion of the elastic member contacts the ejection surface.

7. The inkjet recording apparatus according to claim 1, wherein the plate member extends along a longitudinal direction of the at least one inkjet head, and
wherein an upper surface of the plate member is inclined downward from a middle portion of the upper surface of the plate member toward opposite end portions of the upper surface thereof in a direction perpendicular to the longitudinal direction of the at least one inkjet head.

8. The inkjet recording apparatus according to claim 1, wherein the plate member extends along a longitudinal direction of the at least one inkjet head,
wherein an upper surface of the plate member is formed such that a middle portion of the upper surface thereof is recessed downward relative to opposite end portions of the upper surface thereof in a direction perpendicular to the longitudinal direction of the at least one inkjet head, and
wherein at least one through hole is formed in the middle portion of the upper surface of the plate member, penetrating through the plate member in a thickness direction thereof.

9. The inkjet recording apparatus according to claim 8, wherein said at least one through hole is a plurality of through holes that are formed along a longitudinal direction of the plate member in the middle portion of the upper surface of the plate member, and
wherein said at least one discharge outlet is a plurality of discharge outlets that are arranged in such positions to be opposed to the plurality of through holes.

10. The inkjet recording apparatus according to claim 1, wherein the plate member has a plurality of grooves on a side of an outer circumferential side surface thereof, the grooves extending in a thickness direction of the plate member, and
wherein a width of the groove is made such that capillary action occurs in the ink.

11. The inkjet recording apparatus according to claim 1, wherein a water-repellent layer is formed on at least a part of at least upper surface of the plate member.

12. The inkjet recording apparatus according to claim 1, wherein the cap includes a support member that constitutes the bottom surface portion, and
wherein the elastic member is fixed to and supported by the support member.

13. The inkjet recording apparatus according to claim 1, wherein the plate member is located to be distant from the inner circumferential surface of the elastic member.

14. The inkjet recording apparatus according to claim 1, wherein the contact portion extends from the inner circumferential surface of the elastic member such that an edge of the contact portion is aligned with a periphery of the plate member in a vertical direction of the cap.

15. The inkjet recording apparatus according to claim 1, wherein, in a state in which the end portion of the elastic member is in contact with the ejection surface, an edge of the contact portion is positioned outside an area of the ejection surface where the plurality of nozzles are formed.
